(19) United States
(12) Patent Application Publication
(10) Pub. No.: US 2013/0292500 A1
(43) Pub. Date: Nov. 7, 2013

(54) Nozzle Body and Device Head of a Cleaning Device Comprising Said Type of Nozzle Body

(71) Applicant: Emilia Steinicke, Limeshain (DE)

(72) Inventor: Emilia Steinicke, Limeshain (DE)

(21) Appl. No.: 13/809,405

(22) PCT Filed: Jul. 11, 2011
(86) PCT No.: PCT/DE11/01446

§ 371 Date: Jul. 25, 2013

(30) Foreign Application Priority Data
Jul. 9, 2010 (DE) 10 2010 026 720.1

(51) Int. Cl. B05B 1/00

(52) U.S. Cl. CPC B05B 1/005
USPC 239/590.5

(57) ABSTRACT

A nozzle body is disclosed. The nozzle body includes a nozzle head which begins at a front end face of the nozzle body, a shaft which is connected to the nozzle head and ends at a rear end face of the nozzle body, and a ceramic insert. A longitudinal channel runs through the nozzle body and opens into the front and rear end faces of the nozzle body. An annular surface facing the rear end face of the nozzle body is formed in the longitudinal channel of the nozzle body. The ceramic insert has a longitudinal channel that is concentric with the longitudinal channel of the nozzle body, the ceramic insert is disposed in the longitudinal channel of the nozzle body, and the ceramic insert is in contact with the annular surface. A rear end of the shaft protrudes beyond the ceramic insert and forms an edge.

This application claims the priority of International Application No. PCT/DE2011/001446, filed Jul. 11, 2011, and German Patent Document No. 10 2010 026 720.1, filed Jul. 9, 2010, the disclosures of which are expressly incorporated by reference herein.

### BACKGROUND AND SUMMARY OF THE INVENTION

The invention relates to a nozzle body having a nozzle head, which begins on a front end face of the nozzle body, and a shaft connected to the nozzle head, ending in a rear end face of the nozzle body, wherein the outer lateral surface of the shaft is provided with a thread, and the nozzle body is designed so that a turning tool can be used to screw the nozzle head into a threaded hole of the device head of a cleaning device, and wherein a longitudinal channel runs through the nozzle body, opening into the end faces at both ends.

Such a nozzle body is described in German Patent Document No. DE 20 2009 000 402 U1. The longitudinal channel forms a nozzle channel and is provided with guide ribs for flow stabilization on the inside, formed in one piece with the nozzle body.

In addition, it has already been proposed that a sleeve-shaped ceramic insert having a longitudinal channel concentric with the former is to be inserted into the longitudinal channel of the nozzle body, covering the wall of the longitudinal channel of the nozzle body in a partial section. The uncovered section of the longitudinal channel in the nozzle body and the longitudinal channel of the ceramic insert form a continuous nozzle channel. This measure has proven necessary with an insert of the nozzle body in a channel cleaning device in particular because the rinse water, which flows at high pressure through the nozzle channel, is mixed with abrasive particle, which would rapidly destroy a nozzle body made entirely of steel. Furthermore, it has been found that the rinse water penetrates the nozzle body and damages its thread.

The invention is based on the problem of creating a nozzle body, which is designed so that it can be fitted accurately into a threaded hole in the device head of a cleaning device, namely in such a way that a ceramic insert, which is inserted into the nozzle body, is held there securely, and turbulence in the rinse water is suppressed as much as possible. Furthermore, another goal to be achieved is preventing the rinse water from penetrating into the area between the outer lateral surface of the nozzle body and the inner lateral surface of the threaded hole.

To achieve this object, the invention proposes that an annular surface facing the rear end face be formed in the longitudinal channel of the nozzle body, and a ceramic insert having a longitudinal channel concentric therewith be inserted in the longitudinal channel of the nozzle body, so that it is in contact with the annular surface, the rear end of the shaft protruding beyond the ceramic insert that has been inserted, forming a flangeable edge.

In this design, the ceramic insert is inserted into the shaft of the nozzle body. Then the nozzle body is screwed into a threaded hole, such that the rear edge of the shaft first comes in contact with the bottom of the threaded hole. If the nozzle body is then screwed further into the threaded hole, the edge is flanged at the bottom and folded inward, so that it comes into contact with the ceramic insert and holds it in the nozzle body. The risk that the ceramic insert may be damaged is low because some of the compressive forces are introduced into the shaft of the nozzle body instead of being introduced into the ceramic insert itself. At the same time, the flanged edge forms a seal between the ceramic insert and the bottom of the threaded hole, preventing rinse water from reaching the outside of the nozzle body.

Any small gap of a few hundredths of a millimeter that might remain at first between the flanged edge and the bottom of the threaded hole will become smaller and smaller as the nozzle body is tightened, so that the gap practically disappears and the end face of the ceramic insert is in contact with the bottom of the threaded hole. An additional sealing effect is achieved due to the surface contact, so that the rinse water, which is under pressure, cannot reach the thread.

To facilitate the flanging, the edge may form a cone, wherein the outside of the edge tapers conically toward the rear end face of the nozzle body. The inner lateral surface of the edge preferably runs in a straight extension of the lateral surface of the longitudinal channel in the shaft.

The cone may be embodied in two steps. For example, the angle of inclination with respect to a perpendicular line to the longitudinal axis of the nozzle body may at first be 15°, beginning at the tip, and thereafter it may be 45°.

The nozzle body may be manufactured especially easily if the longitudinal channel runs cylindrically in the area of the shaft and the annular surface runs perpendicular to the longitudinal axis, and accordingly the nozzle body also has a cylindrical shape with rear and front end faces running perpendicular to the axis.

The thread preferably does not extend over the entire length of the shaft and instead the rear part of the thread is kept free; the thread thus begins at a distance from the rear end face. This permits easy insertion of the nozzle body into the threaded hole, such that the shaft is aligned with the threaded hole. Screwing it in does not begin until the shaft of the nozzle body is aligned correctly in the threaded hole. This prevents the thread from being tilted when screwed in.

Similarly, the inside thread in the threaded hole may also begin only at a distance from the mouth of the threaded hole in the surface of the device, so that following the mouth, there is first a smooth cylindrical surface that was created by drilling out the inside thread, for example, with a diameter that corresponds to the outside diameter of the thread. As a result of this measure, the first thread pitch is protected from upsetting upon insertion of the nozzle body.

The invention also relates to the device head of a cleaning device having a threaded hole for receiving a nozzle body and having a flat base surface in which a device channel for supplying rinse water terminates. A nozzle body as described previously is screwed into such a device head such that the depth of the threaded hole is smaller than the length of the shaft, so that in being screwed in, the edge of the shaft may be flanged on the base surface as described above and comes to lie between the end face of the ceramic insert and the base surface with a sealing effect, this sealing effect being formed due to the flanging and also due to the surface contact between the rear end face of the ceramic insert and the bottom face of the threaded hole.

In order for the transition between the ceramic insert and the device channel to be as smooth as possible, the diameter of the device channel is adapted to the diameter of the longitudinal channel, at least at the transition.

The present invention thus yields a nozzle body, which is easy to manufacture and has a long lifetime due to the use of a ceramic insert. The thread is not penetrated due to the seal between the ceramic insert and the device, and this also increases its service life.

The shape of the longitudinal channel in the ceramic insert and the longitudinal channel in the nozzle head of the nozzle body may be selected at will. Thus, for example, the longitudinal channel in the ceramic insert may become wider conically in the direction toward the device channel. It should be pointed out that the transitions between the individual channels must always be implemented without steps.

In general, the shape of the longitudinal channel in the nozzle head of the nozzle body will be cylindrical. However, any other symmetrical or even asymmetrical cross-sectional shape, such as a Y shape, may also be selected for shaping the stream. These and other cross-sectional shapes are described in German Patent Document No. DE 103 21 432 A1.

The present invention will be explained in greater detail below on the basis of one exemplary embodiment in the drawings.

### BRIEF DESCRIPTION OF THE DRAWINGS

FIG. 1 shows a longitudinal section through a nozzle body according to the invention,

FIG. 2 shows a detailed diagram of the rear edge of the nozzle body, and

FIG. 3 shows the nozzle body screwed into a device head.

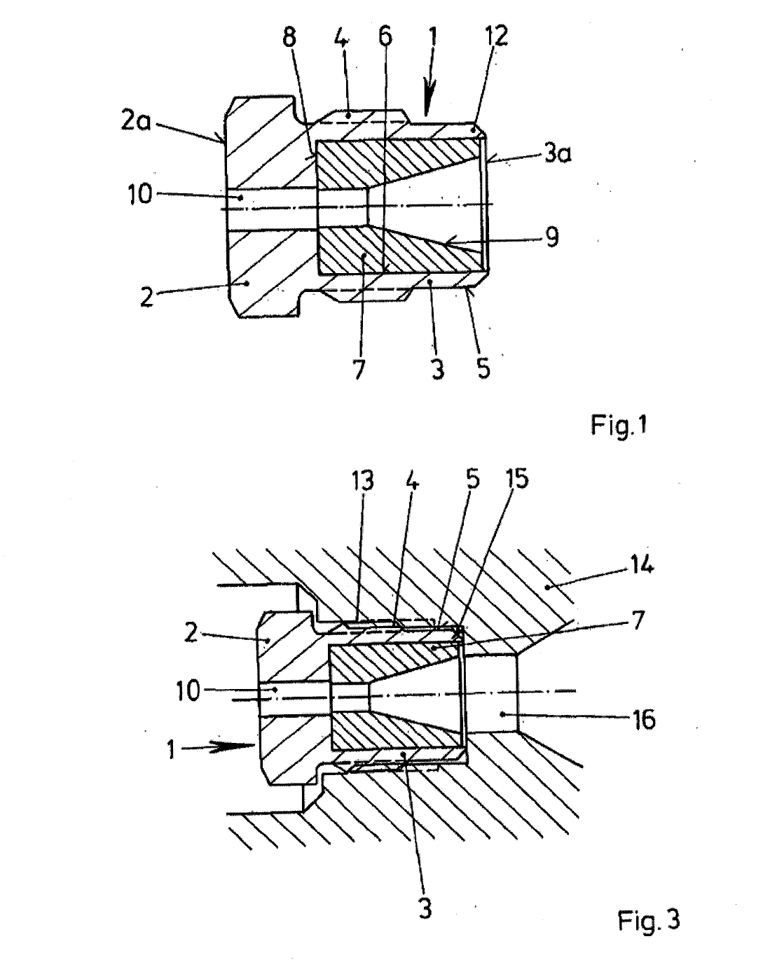

### DETAILED DESCRIPTION OF THE DRAWINGS

The nozzle body 1 consists of a nozzle head 2 and a shaft 3 and is designed with rotational symmetry in relation to its longitudinal axis. A front end face 2a of the nozzle body 1 is situated on the nozzle head 2 and a rear end face 3a is situated on the shaft. Only the nozzle head 2 deviates from the rotational shape, namely it is provided with a hexagonal area to allow the use of a wrench.

A thread 4 is provided on the outer lateral surface of the shaft 3, namely in the area near the nozzle head 2. The area on the rear end of the shaft 3 has no thread and serves as an insertion area 5.

The nozzle body 1 is provided with a longitudinal channel 6, which is provided with a step. The longitudinal channel has a larger diameter in the area of the shaft than in the area of the nozzle head. In the area of the nozzle head, the longitudinal channel 6 serves as a nozzle channel. In the area of the shaft, a ceramic insert 7 is inserted into the longitudinal channel 6, said ceramic insert having a cylindrical outer shape and being inserted in such a way that it fits accurately and is adhesively bonded.

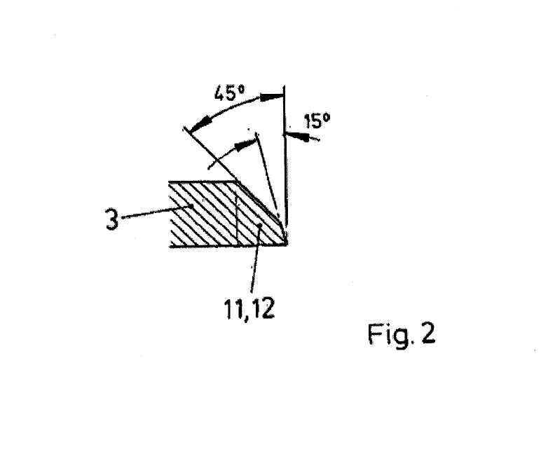

The front end face of the ceramic insert lies in contact with an annular surface 8 forming the step between the two sections of the longitudinal channel 6 having different diameters, wherein the ceramic insert is also adhesively bonded to the annular surface 8. In this exemplary embodiment, the ceramic insert 7 has a longitudinal channel 9, which widens toward the rear and is aligned with the section of the longitudinal channel 6 in the nozzle head and forms a nozzle channel 10 with it. In the inserted state in which the ceramic insert 7 is in contact with the annular surface 8, the rear end of the shaft 3 protrudes slightly, preferably only 0.1 mm beyond the end face of the ceramic insert 7, wherein the outer lateral surface of the shaft 3 forms a two-step cone 11 in this area, as shown in FIG. 2, and thus forms a flangeable edge 12. The angle of inclination of the conical surfaces following the rear end face is 15°, and following that it is 45°, each in relation to a line perpendicular to the longitudinal axis of the nozzle body 1. The inside of the cone 11 is a straight extension of the inner lateral surface of the longitudinal channel 6 in the shaft 3.

As shown in FIG. 3, the nozzle body 1 can be screwed into a threaded hole 13 in the device head 14 of a cleaning device, wherein the threaded hole 13 has a flat base surface 15, with a device channel 16 opening at its center.

The threaded hole 13 has an inside thread, which ends at a distance from the mouth of the threaded hole 13 in the device surface, so that following this mouth, there is an unthreaded section, which has a cylindrical surface and serves as a guide surface for insertion of the nozzle body 1.

According to this diagram, the nozzle body 1 is screwed in until its rear edge is just in contact with the base surface 15. When the nozzle body 1 is screwed in further, the edge is flanged inward, so that, on the one hand, it is in contact with the rear end face of the ceramic insert 7 and thus holds the ceramic insert 7 in the nozzle body 1, while, on the other hand, it forms a gasket that seals the transition between the device channel 16 and the nozzle channel 10 with respect to the threaded hole 13. Since there is only a minor overhang of the edge with respect to the ceramic insert 7, the ceramic insert 7 can be pressed against the base surface 15 despite the flanging, so that an additional sealing effect is achieved.

As further shown in FIG. 3, the transitions between the aforementioned channels 10, 16 are free of steps, have sharp edges, and are smoothed, so that no turbulence can form in the flowing rinse water.

The nozzle body is suitable in particular for insertion into channel cleaning devices having a device head with nozzle bodies distributed uniformly on the circumference thereof. The stream outlet directions of the nozzle bodies are skewed in relation to the longitudinal axis of the device, wherein the angle of the stream outlet direction to the longitudinal axis of the device head is selected so that, on the one hand, the result is forward propulsion due to the pressure of the stream, and, on the other hand, the channel walls to be cleaned can still be reached with a sufficiently high pressure. The distance from the stream outlet direction to the longitudinal axis of the device (as a measure of the skewed position) is selected so that one component in the tangential direction strikes the channel walls obliquely at the side, thereby increasing the cleaning effect. Furthermore, the tangential component of the stream can be utilized to induce rotation of the device head about its longitudinal axis. To do so, however, it must be supported on a carriage to permit it to rotate about its longitudinal axis.

### LIST OF REFERENCE NUMERALS

1 nozzle body

2 nozzle head

2a end face

3 shaft

3a end face

4 thread

5 insertion area

6 longitudinal channel

7 ceramic insert

8 annular surface

9 longitudinal channel

10 nozzle channel

11 cone

12 edge

13 threaded hole

14 device head

15 base surface

16 device channel

1.-8. (canceled)

9. A nozzle body, comprising:
a nozzle head which begins at a front end face of the nozzle body;
a shaft which is connected to the nozzle head and ends at a rear end face of the nozzle body, wherein an outer lateral surface of the shaft includes a thread;
wherein a longitudinal channel runs through the nozzle body and opens into the front and rear end faces of the nozzle body;
wherein an annular surface facing the rear end face of the nozzle body is formed in the longitudinal channel of the nozzle body; and
a ceramic insert, wherein the ceramic insert has a longitudinal channel that is concentric with the longitudinal channel of the nozzle body, wherein the ceramic insert is disposed in the longitudinal channel of the nozzle body, wherein the ceramic insert is in contact with the annular surface, and wherein a rear end of the shaft protrudes beyond the ceramic insert and forms an edge.

10. The nozzle body according to claim 9, wherein the edge is formed by a cone and wherein the edge tapers conically toward the rear end face of the nozzle body.

11. The nozzle body according to claim 10, wherein the edge tapers conically in at least two different angles of inclination toward the rear end face of the nozzle body.

12. The nozzle body according to claim 9, wherein the longitudinal channel of the nozzle body runs cylindrically in an area of the shaft, wherein the annular surface is perpendicular to a longitudinal axis of the nozzle body, and wherein the nozzle body has a cylindrical shape with the rear and front end faces perpendicular to the longitudinal axis.

13. The nozzle body according to claim 9, wherein the thread begins at a distance from the rear end face of the nozzle body such that an unthreaded insertion area is located on a rear end of a lateral surface of the nozzle body.

14. The nozzle body according to claim 9 in combination with a cleaning device, wherein the cleaning device includes a head, wherein the head includes a threaded hole, and wherein an inside thread of the threaded hole begins at a distance from a mouth of the threaded hole such that an unthreaded guide surface following the mouth is included in the threaded hole.

15. A device head of a cleaning device having a threaded hole in combination with the nozzle body according to claim 9, wherein the threaded hole of the cleaning device has a flat base surface in which a device channel ends, wherein a length of the shaft of the nozzle body is greater than a depth of the threaded hole of the device head.

16. The device head according to claim 15, wherein the device channel and the longitudinal channel of the ceramic insert have a same diameter at a transition of the device channel to the longitudinal channel of the ceramic insert.
